(19) United States
(12) Patent Application Publication
(10) Pub. No.: US 2002/0107708 A1
(43) Pub. Date: Aug. 8, 2002

(54) Method of and system for financial services fulfilment

(76) Inventors: William D. Lester, Plano, TX (US); Larry K. Anders, Arlington, TX (US); Dustin D. Arnold, Frisco, TX (US); Carl P. Brandt, Dallas, TX (US)

Correspondence Address: JENKENS & GILCHRIST, 3200 Fountain Place, 1445 Ross Avenue, Dallas, TX, 75202-2799, US

(21) Appl. No.: 10/056,180

(22) Filed: Jan. 23, 2002

Related U.S. Application Data
(60) Provisional application No. 60/263,938, filed on Jan. 24, 2001.

(51) Int. Cl. G06F 17/60

(52) U.S. Cl. 705/4

(57) ABSTRACT

A method and system for conducting a financial transaction involving the acquisition of a financial product. The method according to one aspect of the invention comprises the steps of making an application for acquisition of a financial product that requires activation to become effective, processing the application for approval, and, following approval of the application, activating the financial product to complete the financial transaction, wherein the steps of making, processing and activating are all conducted through a global communications network. The present invention permits a financial product, such as a life insurance policy, to be applied for, the application processed for approval, and, if approved, substantially immediately activated to provide substantially immediate coverage to the applicant during a single Internet session.

This application claims the benefit of copending U.S. Provisional Patent Application Serial No. 60/263,938 filed Jan. 24, 2001.

### BACKGROUND OF THE INVENTION

1. Field of the Invention

The present invention relates generally to the field of eCommerce financial activity. More particularly, but not by way of limitation, the present invention relates to a method and system for conducting a financial transaction, such as the acquisition of an insurance policy, via a global communications network, such as the world wide web.

2. Description of the Prior Art

Many financial transactions currently take place over the world wide web. Among such transactions include paying bills; conducting various banking activities, such as transferring funds from one account to another; and trading in securities, such as buying or selling stocks. Many consumers enjoy the convenience of being able to conduct such transactions from their home or office via the world wide web, and many businesses find the web to be an effective tool for reducing costs and expanding their customer base.

Among the variety of financial products that are currently offered for sale via a global communications network include insurance policies, such as life insurance policies. In particular, a consumer interested in purchasing an insurance policy may be invited to fill out an application or to otherwise apply for the policy over the web. Although such procedures can facilitate the over-all process of applying for an insurance policy, it is still necessary that the policy be approved by the insurance provider, that the necessary premium be paid and that coverage under the policy be put into effect. Frequently, a significant period of time elapses between the time that an application is filed over the web and the policy actually becomes effective. This time delay and the uncertainty associated with such delay is often undesirable and can discourage many consumers from using the web to purchase insurance policies. Similar problems apply with respect to other financial products that are offered for sale over the world wide web.

There is, accordingly, a need for a method and system for conducting a financial transaction, such as the acquisition of an insurance policy, in such a manner that the transaction can be processed to completion in a substantially immediate manner using a global communications network such as the world wide web.

### SUMMARY OF THE INVENTION

The present invention relates to a method and system for conducting a financial transaction involving the acquisition of a financial product utilizing a global communications network.

A method for conducting a financial transaction according to one aspect of the present invention comprises the steps of making an application for acquisition of a financial product that requires activation to become effective, processing the application for approval, and, following approval of the application, activating the financial product to complete the financial transaction, wherein the steps of making, processing and activating are all conducted through a global communications network.

According to the present invention, an applicant that wishes to acquire a financial product can access a web site of a service provider that provides financial transaction services and complete an application to acquire the financial product. The application is substantially immediately reviewed; and, if the application is approved, the financial product is substantially immediately activated by the provider of the financial product and becomes effective. With the present invention, accordingly, the entire acquisition process can be completed during a single internet session; and before disconnecting from the web site, the applicant will know, not only whether the application has been accepted, but if accepted, that the financial product has been activated and is in effect.

According to a presently preferred embodiment of the invention, the financial product comprises an insurance policy, such as a life insurance policy, and the method includes the steps of making an application to purchase an insurance policy, processing the application for approval, and, upon approval, activating the policy to provide immediate coverage thereunder. Thus, with the present invention, an approved applicant will be covered under the policy before he disconnects from the web site.

According to a further embodiment of the invention, the method further includes the step of paying for the financial product prior to the activation step. Payment can also conveniently be made through the global communications network by using a credit card, by authorizing a withdrawal from a bank account, or in another appropriate manner. In this way, the provider of the financial product is assured payment for the product before the product is activated.

According to yet further embodiments of the invention, the method may include further steps that are performed subsequent to activation of the financial product. For example, an applicant could be required to sign and return a written agreement within a specified period of time. Also, provisions can be provided to cancel activation of the financial product if it is found that the applicant has furnished false information on the application. Any of these subsequent steps do not prevent the financial product from being substantially immediately activated; but provide a means by which the provider of the financial product can cancel the activation for good cause.

According to a further embodiment of the invention, a system for conducting a financial transaction using a global communications network is provided. The system preferably comprises a three-tier architecture including a presentation layer, a business logic layer and a data layer. The presentation layer permits communication between users of the system and the business logic layer. The business logic layer provides the core system engine that drives the functionality of the system, and the data layer stores all the necessary application data.

In general, the present invention provides a method and system by which a financial transaction involving the acquisition of a financial product, such as an insurance policy, can be completed in a substantially immediate manner in a single session utilizing a global communications network such as the world wide web. The present invention, accordingly, provides increased convenience to the consumer and reduced costs and enhanced business opportunities to the provider of the financial product. The financial transaction service provider can be the same entity as the provider of the financial product, or it can be a different entity that functions as a “middle man” between the applicant and the financial product provider.

### BRIEF DESCRIPTION OF THE DRAWINGS

A more complete understanding of the method and system of the present invention may be obtained by reference to the following Detailed Description of Presently Preferred Embodiments when taken in conjunction with the accompanying Drawings wherein:

FIG. 1 is a flowchart that illustrates a method for conducting a financial transaction via a global communications network according to a presently preferred embodiment of the present invention;

FIG. 2 illustrates an exemplary welcoming screen that is displayed when an applicant accesses a web site of a financial transaction service provider during performance of the method of FIG. 1;

FIG. 3 illustrates an exemplary inquiry screen that is displayed during performance of the method of FIG. 1;

FIGS. 4, 5 and 6 illustrate exemplary application screens that are displayed during performance of the method of FIG. 1;

FIG. 7 illustrates an exemplary policy premium information screen that is displayed during performance of the method of FIG. 1;

FIG. 8 illustrates an exemplary disclaimer screen that is displayed during performance of the method of FIG. 1;

FIG. 9 illustrates an exemplary payment screen that is displayed during performance of the method of FIG. 1;

FIG. 10 illustrates an exemplary activation notification screen that is displayed during performance of the method of FIG. 1;

FIG. 11 is a diagram that schematically illustrates a three-tier architecture implementation of a system for conducting a financial transaction through a global communications network according to a further embodiment of the present invention;

FIG. 12 is a diagram that schematically illustrates the information flow utilizing the three-tier architecture implementation of FIG. 12; and

FIG. 13 is a diagram that schematically illustrates the logical system of the three-tier architecture implementation of FIG. 11.

### DETAILED DESCRIPTION OF PRESENTLY PREFERRED EMBODIMENTS OF THE INVENTION

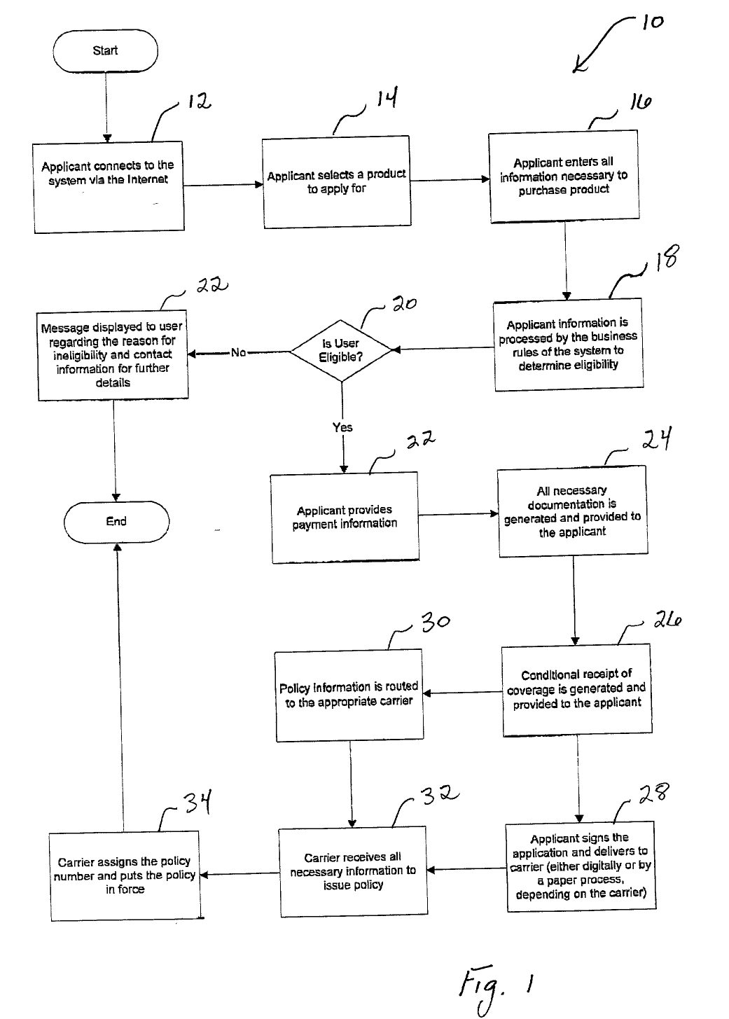

FIG. 1 is a flow chart that schematically illustrates steps of a method for conducting a financial transaction involving the acquisition of a financial product through a global communications network, such as the world wide web, according to a presently preferred embodiment of the invention. In the flow chart of FIG. 1, and in the following description thereof, it is assumed that the financial product is a life insurance policy and that the financial transaction comprises the sale and purchase of a life insurance policy. It should be understood, however, that this is intended to be exemplary only as the financial transaction may comprise the sale and purchase of another form of insurance policy or the acquisition of another type of financial product that requires some form of activation in order to complete the financial transaction.

In order to perform the method illustrated in FIG. 1, a web site is first established that is preferably dedicated to the online fulfillment of the financial transaction to be conducted. The web site is provided by a service provider that provides financial transaction services to permit the financial transaction to be carried out. The service provider may be the same entity as the provider of the life insurance policy, or, most preferably, it is a different entity that functions as a “middle man” between an applicant and the provider of the life insurance policy. A preferred manner in which the web site can be constructed will be described in detail hereinafter.

The method illustrated in FIG. 1 is generally designated by reference number 10, and begins by an applicant connecting to the service provider's web site from a computer via the Internet as shown in step 12. The applicant can connect to the system web site directly or he can be directed to the system web site by a provider of the insurance policy, e.g., via a banner and/or a button on the policy provider's own web site.

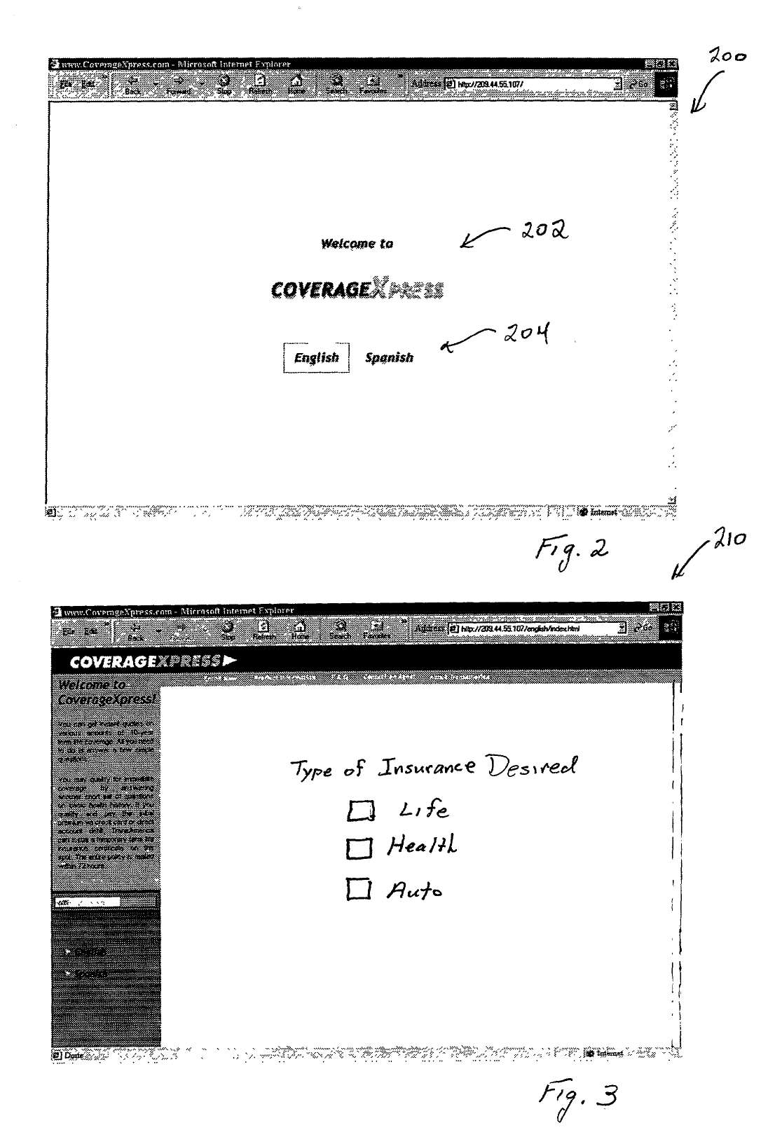

When the service provider's web site is accessed, a screen is displayed on the applicant's computer monitor welcoming the applicant to the web site. The welcoming screen may provide various types of information to the applicant and/or request certain information from the applicant. An exemplary welcoming screen 200 is illustrated in FIG. 2, and includes a statement welcoming the applicant to the web site as shown at 202, and a request that the applicant select a language to be used in subsequent screens as shown at 204. In FIG. 2, a choice of English or Spanish is illustrated. This is intended to be exemplary only as the method and system of the present invention can be offered in any one or more desired languages.

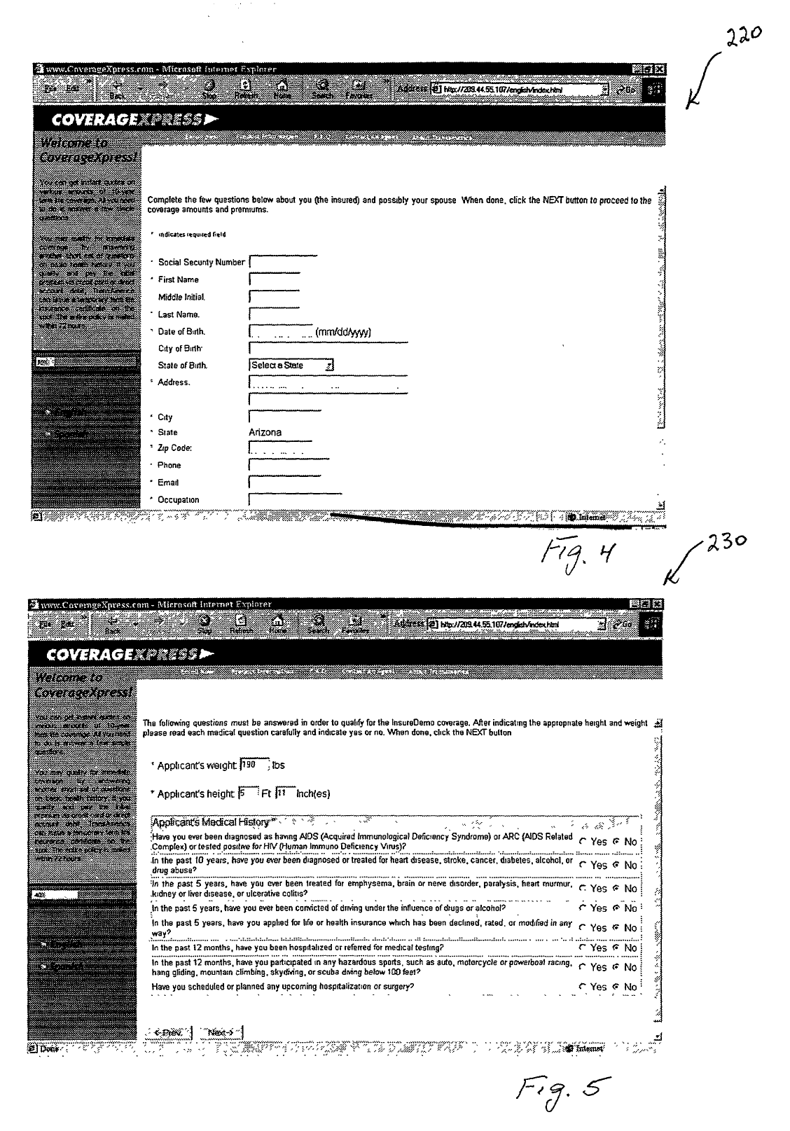

It is contemplated that the method and system of the present invention may provide an applicant an opportunity to apply for the purchase of a plurality of different financial products. In such a circumstance, the next step of method 100 is for the applicant to select the financial product; e.g., the type of insurance policy, that he wishes to purchase as shown at step 14 in FIG. 1. FIG. 3 illustrates an exemplary inquiry screen 210 that may be provided for such selection. In other embodiments of the invention, only one financial product may be available for acquisition in which case step 14 and screen 210 may be omitted.

Assuming a life insurance policy is selected by the applicant in step 14, one or more additional screens maybe displayed to provide the applicant with information regarding the selected policy. For example, if the policy is available for purchase in only selected geographical areas, or to selected classes of people, the applicant can be so advised at this time. In alternative embodiments of the invention, one or more screens may be displayed at this time to gather additional information regarding the life insurance policy that the applicant wishes to purchase. For example, if an applicant has indicated an interest in a life insurance policy in step 14, a subsequent screen may ask the applicant to select a particular type of life insurance policy that is desired, e.g., term life insurance, whole life insurance, etc.

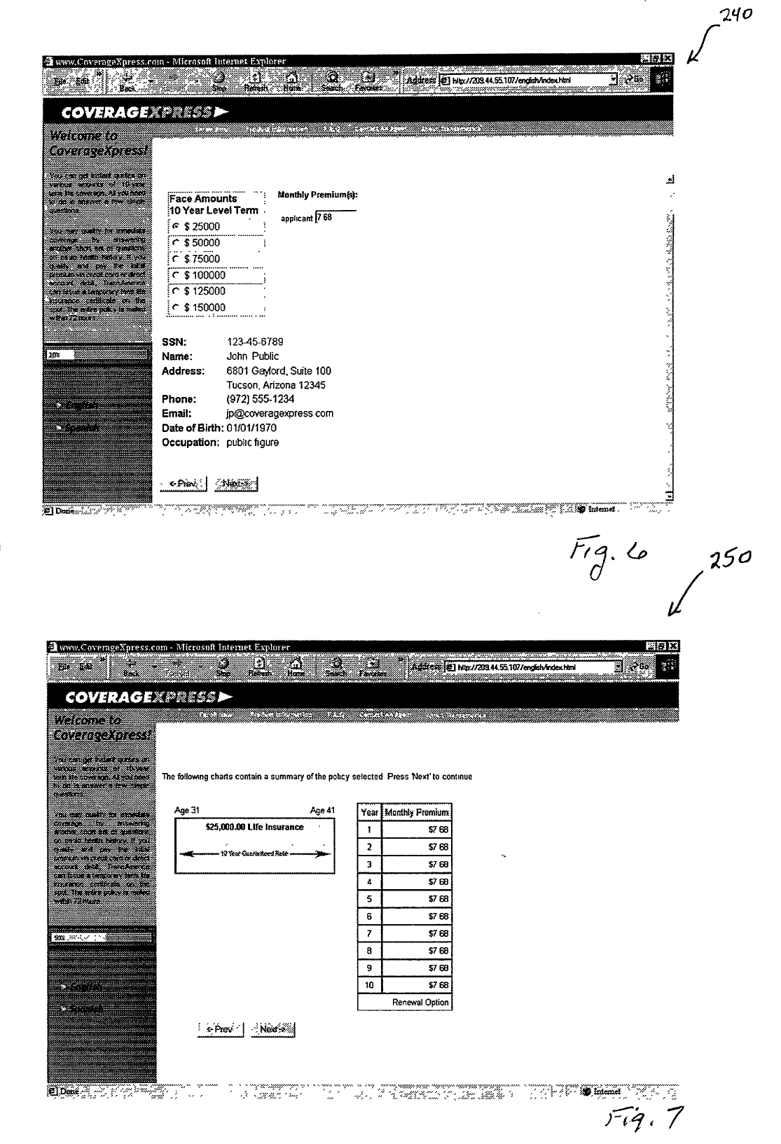

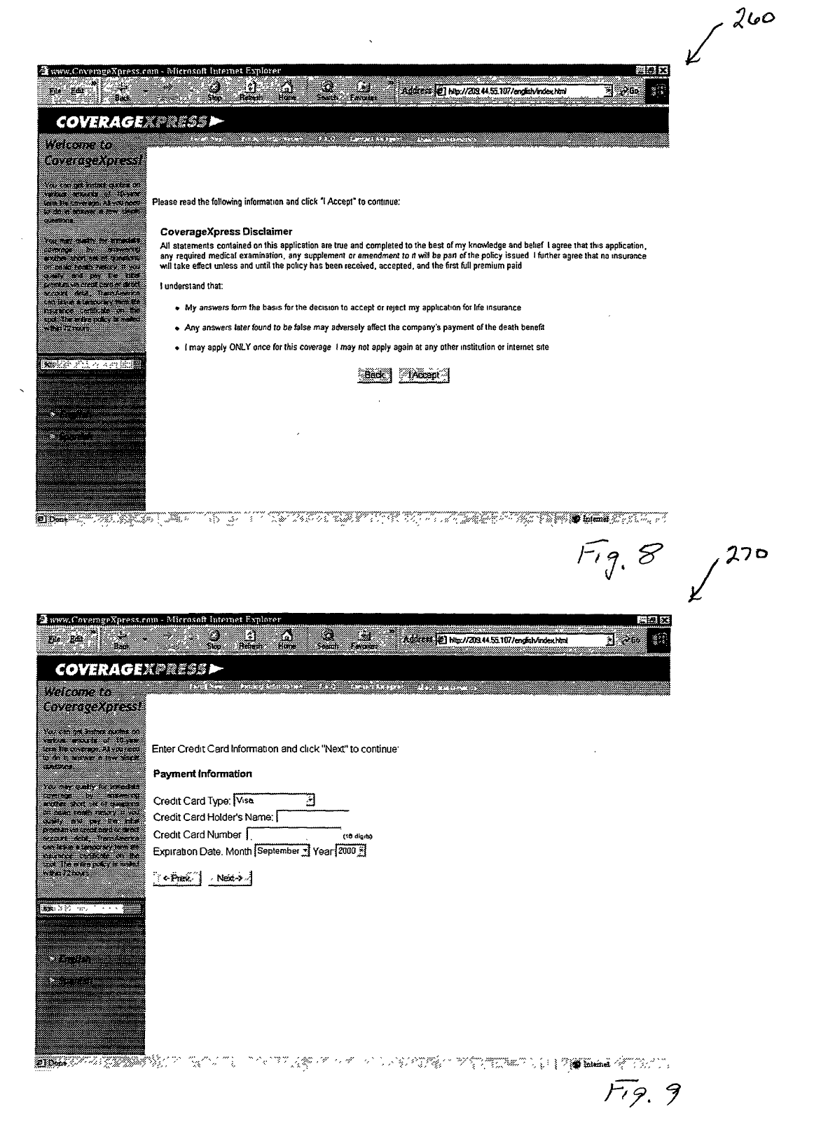

In general, once the applicant has selected the financial product he wishes to purchase, one or more screens are then displayed to permit the applicant to enter all information necessary to apply for purchase of the product as shown at step 16. Typical of such information required to apply for a life insurance policy includes the applicant's name, social security number, date of birth, current address, phone number, occupation, gender, the amount of insurance coverage desired, beneficiary information, whether the applicant is married or a smoker, etc. The required information is normally chosen by the provider of the life insurance policy, and may be changed from time to time as desired by the provider. The requested information may be provided on one or more screens. For example, a single scrollable screen or a plurality of separate screens may be utilized. FIGS. 4, 5 and 6 illustrate exemplary application screens 220, 230 and 240, respectively.

The application data that is collected in step 16 is stored in a database as will be described hereinafter. Preferably also, the data entered by the applicant is continuously monitored as it is being entered. In this way, if an applicant enters data that disqualifies him from acquiring the financial product for which he is currently applying, the system can so advise the applicant so that he will not spend further time providing additional information. Alternatively, the system may suggest a more appropriate financial product to the applicant or may send a message telling the applicant that he will be contacted via telephone by a licensed agent. Also, depending on particular information entered by the applicant, the system might display additional screens to gather further information as may be necessitated by the entered information. For example, if an applicant enters information concerning a particular health problem, the system may request further information regarding that health problem.

When the applicant has furnished all the requested information in step 16, the information is then processed by the system in step 18 to determine the eligibility of the applicant to acquire the life insurance policy. This determination is made based on business rules programmed into the system as selected by the provider of the insurance policy. If it is determined that the applicant is ineligible for the requested insurance policy (No output of question box 20), a message screen is displayed, as shown at step 22 advising the applicant of the reason for the ineligibility determination; and, perhaps, providing contact information by which the applicant can get more details regarding the determination.

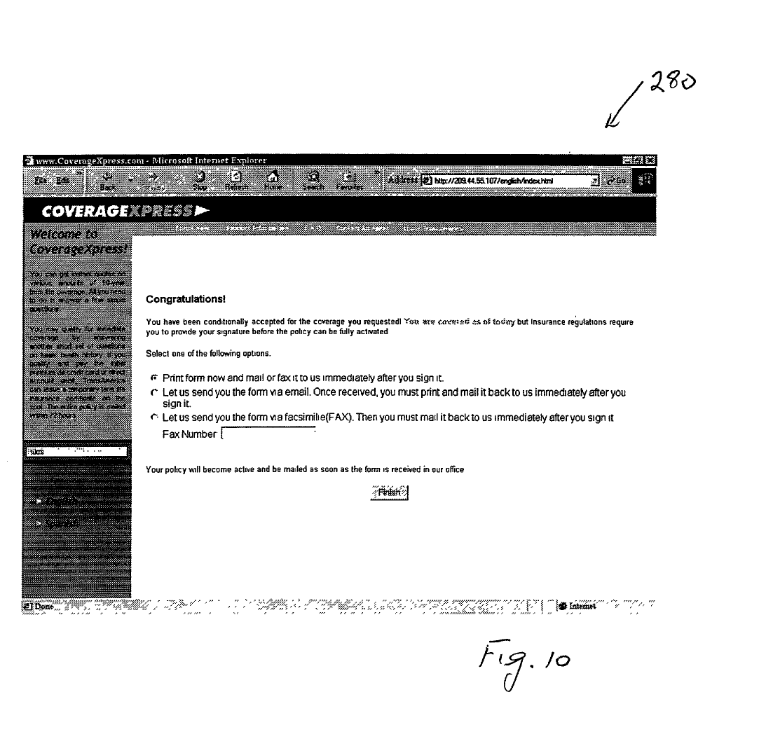

If it is determined that the applicant is eligible for the requested insurance policy (Yes output of question box 20), one or more additional screens may be displayed advising the applicant that he is eligible and providing other pertinent information. For example, by utilizing information gathered from previous screens, the premium the applicant will be charged to purchase the insurance policy may be displayed from a rate table developed by the provider of the policy. An exemplary policy premium information screen 250 is illustrated in FIG. 7. This screen may also permit the applicant to select whether he wishes to pay the premium on a monthly basis or on some other basis. A screen, such as screen 260 illustrated in FIG. 8, may also be displayed providing various disclaimers and asking the applicant to confirm that all information provided in the application is accurate.

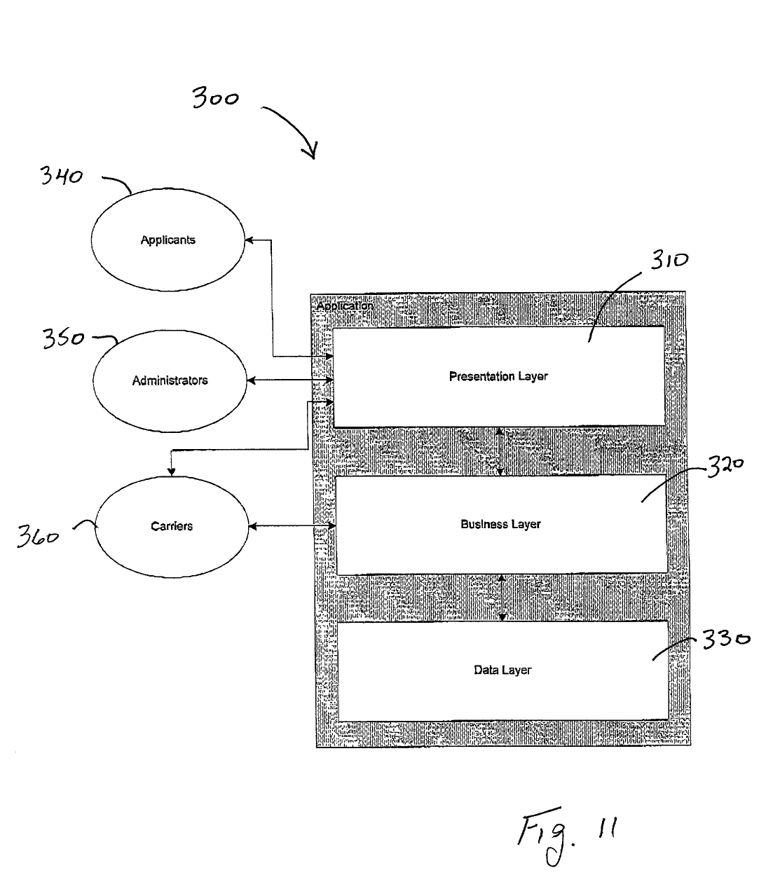

The applicant is then asked to provide payment information as shown at step 22 in FIG. 1. An appropriate screen is displayed to ask the applicant to select a method of payment, e.g., credit card or checking account withdrawal; and, thereafter, the necessary information to complete the payment is requested, using, for example, a screen such as screen 270 illustrated in FIG. 9,.

After the payment information has been provided and processed, all necessary documentation relating to the policy is generated by the system and provided to the applicant as shown in step 24; and, thereafter, a conditional receipt of coverage is also generated and provided to the applicant as shown in step 26. The applicant is then requested to sign the application as shown in step 28, and the policy information is also routed to the provider of the policy as shown in step 30. When the policy provider has received all necessary information, step 32, the provider assigns a policy number and activates the policy such that the applicant is immediately covered by the policy, step 34. An activation notification screen is then displayed to the applicant as illustrated by exemplary screen 280 in FIG. 10. Signing of the application may be done either digitally or may be completed at a later time by a paper process depending on the requirements of the policy provider.

At this time, the policy has been issued and coverage is provided. Additional requirements, however, may be specified by the provider of the policy in order to prevent later cancellation of the policy. For example, if it is later determined that the applicant has misrepresented any information on the application, coverage can be canceled. Also, as indicated above, an actual signature may be required to complete the process. In this regard, it is contemplated that the policy provider will deliver the actual policy to the applicant to be signed and returned to the provider within a specified period of time, for example, 72 hours.

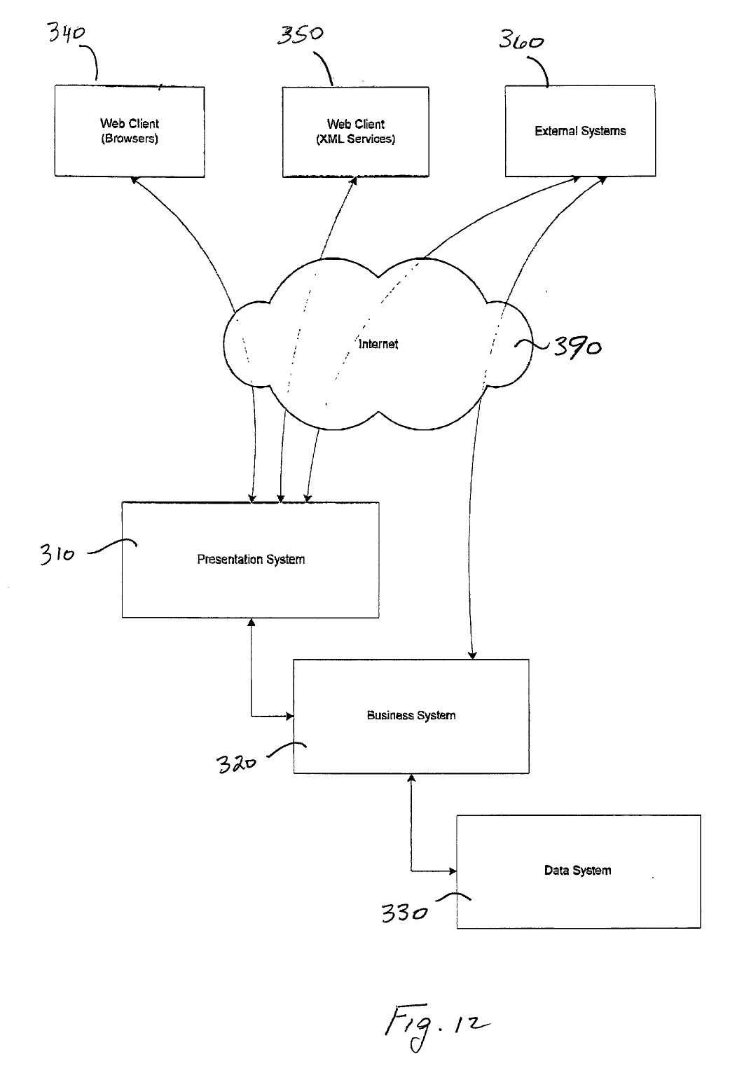

FIG. 11 is a diagram that schematically illustrates a system 300 for conducting a financial transaction involving the acquisition of a financial product according to a presently preferred embodiment of the present invention. As shown, system 300 incorporates a three-tier architecture comprising a presentation layer 310, a business logic layer 320 and a data layer 330. The presentation layer 310 provides a means of communication between users 340 and 350 of the system. The two primary presentation formats are standard HTML format and XML web service format. The HTML presentation layer provides human users with the ability to interact with the system. The XML web services presentation layer provides a means to allow external sources, illustrated at 360, to connect to and leverage the business and/or data functionality of the system using open standards. The presentation layer 310 of the system has been designed to be interchangeable with other open-standard presentation methods.

The business logic layer 320 of the system provides the core system engine that drives the functionality of the system. The business logic layer contains all information necessary to connect to the other layers. Flexible business rules have been designed into this part of the system to allow custom workflows for product-specific implementations of the system. The business logic layer also controls all of the information flow between users of the system and their data.

The data layer 330 provides a means to store all of the application data. The system has been designed to allow interchangeability between the existing relational database management system and other SQL-compliant database management systems.

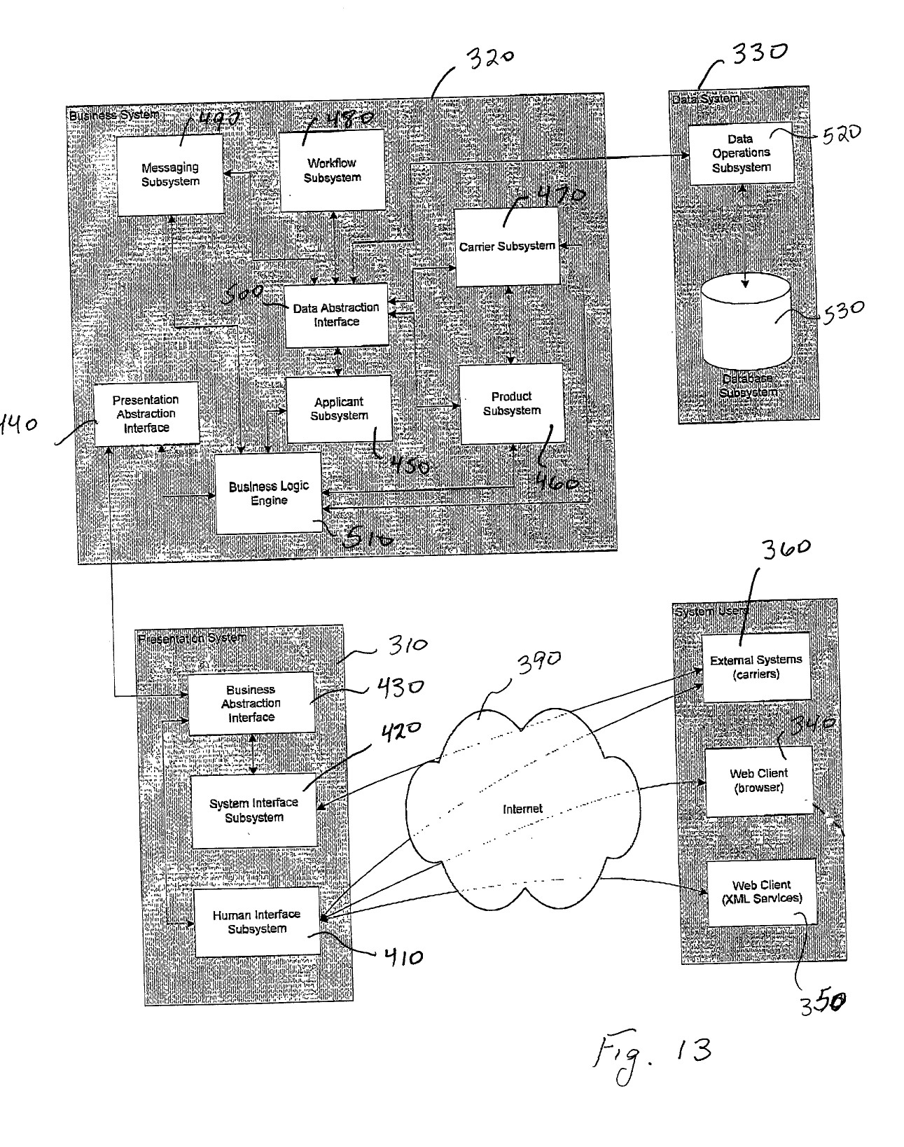

FIG. 12 is a diagram that schematically illustrates the information flow of the three-tier architecture implementation illustrated in FIG. 11. As shown, data flows from web clients 340, 350 to the presentation layer 310 via the Internet 390, and external systems 360 are also connected to the presentation layer 310 and to the business logic layer 320 via the Internet. Data also flows between the presentation layer 310 and the business logic layer 320 and between the business logic layer 320 and the data layer 330 as shown by the arrows.

FIG. 13 is a diagram that schematically illustrates the logical system of the three-tier architecture implementation of FIG. 11 according to a presently preferred embodiment of the invention. As shown, the presentation layer 310 includes a human interface subsystem 410 for interfacing with web clients 340, 350 via the Internet, and a system interface subsystem 420 for interfacing with external systems (carriers) 360, also via the Internet. The presentation layer 310 also includes a business abstraction interface 430 that interfaces with a presentation abstraction interface 440 the in the business logic layer 320. The business logic layer also includes various subsystems including an applicant subsystem 450, a product subsystem 460, a carrier subsystem 470, a workflow subsystem 480 and a messaging subsystem 490 all connected to a data abstraction interface 500. A business logic engine 510 drives the overall system. The data layer 330 includes a data operations subsystem 520 and a database subsystem 530.

In general, the present invention provides a service to both applicants of financial products and providers of the products. With the present invention, essentially all steps of the financial transaction are conducted by the method and system of the invention through approval of the application and generation of the necessary documentation. The provider of the financial product need only activate the product to place it into effect.

While what has been described constitutes exemplary embodiments of the invention, it should be recognized that the invention can be varied in numerous ways without departing from the scope thereof. Accordingly, it should be understood that the invention should be limited only insofar as is required by the scope of the following claims.

We claim:

1. A method for conducting a financial transaction, comprising:
making an application for acquisition of a financial product that requires activation to become effective;
processing said application for approval; and
following approval of said application, activating said financial product to complete said financial transaction, wherein said steps of making, processing and activating are all conducted through a global communications network.

2. The method according to claim 1, and further including the step of paying for said financial product prior to said activating step.

3. The method according to claim 1, wherein said financial product comprises an insurance policy, and wherein said financial transaction comprises selling and buying said insurance policy.

4. The method according to claim 3, wherein said activating step comprises providing coverage under said insurance policy.

5. The method according to claim 4, wherein said insurance policy comprises a life insurance policy.

6. The method according to claim 1, wherein said global communications network comprises a world wide web.

7. The method according to claim 6, wherein said steps of making, processing and activating are all conducted during a single Internet session.

8. The method according to claim 1, wherein said processing step is performed by a financial transaction service provider, and wherein said activating step is performed by a provider of said financial product.

9. The method according to claim 1, wherein said processing and activating steps are performed by the same entity.

10. A method for buying and selling an insurance policy, comprising:
making an application to purchase said insurance policy;
processing said application for approval; and
following approval of said application, providing coverage under said insurance policy, wherein said steps of making, processing and providing coverage are all conducted through a global communications network.

11. The method according to claim 10, and further including the step of paying for said insurance policy prior to said providing coverage step.

12. The method according to claim 10, wherein said insurance policy comprises a life insurance policy.

13. The method according to claim 10, wherein said global communications network comprises a world wide web.

14. The method according to claim 13, wherein said steps of making, processing and providing coverage are all conducted during a single Internet session.

15. The method according to claim 10, wherein said processing step is performed by a financial transaction service provider, and wherein said providing coverage step is performed by a provider of said insurance policy.

16. A system for conducting a financial transaction through a global communications network, comprising:
a first interface for receiving an application from an applicant through the global communications network for acquisition of a financial product that requires activation to become effective;
a processor for processing said application for approval; and
if said application is approved, a second interface for routing application information to a provider of said financial product through the global communications network to obtain substantially immediate activation of said financial product by said provider.

17. The system according to claim 16, wherein said financial product comprises an insurance policy, and wherein said financial transaction comprises selling and buying said insurance policy.

18. The system according to claim 17, wherein said insurance policy comprises a life insurance policy, and wherein said activation comprises providing coverage under said policy.

19. The system according to claim 16, wherein said system is operated by a financial transaction service provider that comprises a different entity than said provider of said financial product.

20. The system according to claim 16, wherein said global communications network comprises a world wide web, and wherein said first and second interfaces comprise Internet connections through said world wide web.
